(19) United States
(12) Patent Application Publication
(10) Pub. No.: US 2025/0219776 A1
(43) Pub. Date: Jul. 3, 2025

(54) METHOD AND SYSTEM FOR JOINT-BAND HETEROGENOUS MULTI-ACCESS POINT COORDINATION

(71) Applicant: Cisco Technology, Inc., San Jose, CA (US)

(72) Inventors: Malcolm M. Smith, Richardson, TX (US); Indermeet S. Gandhi, San Jose, CA (US); Matthew A. Silverman, Shaker Heights, OH (US)

(73) Assignee: Cisco Technology, Inc., San Jose, CA (US)

(21) Appl. No.: 18/675,479

(22) Filed: May 28, 2024

Related U.S. Application Data
(60) Provisional application No. 63/615,438, filed on Dec. 28, 2023.

(51) Int. Cl. H04L 5/00; H04W 16/14; H04W 28/02; H04W 28/08

(52) U.S. Cl. CPC H04L 5/0046; H04L 5/0032; H04W 16/14; H04W 28/0242; H04W 28/08

(57) ABSTRACT

Supporting Multi-Access Point (AP) Coordination (MAPC) across multiple bands may be provided. Supporting multi-band MAPC can include receiving one or more multi-band MAPC capabilities elements from one or more APs. One or more MAPC modes can be determined for a plurality of bands based on the one or more multi-band MAPC capabilities elements. A multi-band MAPC Coordination Group (CG) can be formed including the one or more APs, wherein the multi-band MAPC CG uses the one or more MAPC modes for the plurality of bands.

### RELATED APPLICATION

Under provisions of 35 U.S.C. § 119 (e), Applicant claims the benefit of and priority to U.S. Provisional Application No. 63/615,438, filed Dec. 28, 2023, the disclosure of which is incorporated herein by reference in its entirety.

### TECHNICAL FIELD

The present disclosure relates generally to supporting Multi-Access Point Coordination across multiple bands.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for supporting multi-band Multi-Access Point Coordination (MAPC);

FIG. 2 is a block diagram of a multi-band MAPC capabilities element;

FIG. 3 is a block diagram of an example AP configuration for supporting multi-band MAPC;

FIG. 4 is a flow chart of a method for supporting multi-band MAPC; and

FIG. 5 is a block diagram of a computing device.

### DETAILED DESCRIPTION

### Overview

Supporting Multi-Access Point (AP) Coordination (MAPC) across multiple bands may be provided. Supporting multi-band MAPC can include receiving one or more multi-band MAPC capabilities elements from one or more APs. One or more MAPC modes can be determined for a plurality of bands based on the one or more multi-band MAPC capabilities elements. A multi-band MAPC Coordination Group (CG) can be formed including the one or more APs, wherein the multi-band MAPC CG uses the one or more MAPC modes for the plurality of bands.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In Wi-Fi networks, including enterprise and public networks for example, Access Points (APs) can be deployed in multiple frequency bands (e.g., 2.4 Gigahertz (GHz), 5 GHz and 6 GHZ) for increased capacity. To improve efficiency, Multi-AP Coordination (MAPC) mechanisms can be implemented. To perform MAPC, multiple APs coordinate their transmissions via schedules, via Spatial Reuse (SR), and/or the like. APs implementing MAPC may be dual-band or tri-band APs and may be co-channel on one or more bands with one or more other APs under certain Radio Resource Management (RRM) configurations. Current implementations of MAPC define operating only a single common channel. Using a single common channel limits the ability of APs to utilize the multiple frequency bands to increase capacity, avoid interference and/or the like.

Methods for implementing MAPC using multiple bands is described herein. Using the multiple available bands MAPC APs can alleviate and/or eliminate network issues. For example, multi-band MAPC can reduce the amount of interference some bands face from legacy devices or other technologies, restricting reuse (e.g., Coordinated-SR (C-SR)). Additionally, coordinated scheduling techniques, such as Coordinated-Time Division Multiple Access (C-TDMA) for example, may perform better (e.g., with lower latency) with more Transmit Opportunities (TxOps) that multi-band MAPC can provide. Bands may also have comparatively different path loss, propagation characteristics, and/or other characteristics that can affect which band is best for certain transmissions. Different bands can be selected when implementing multi-band MAPC to leverage the favorable characteristics of the bands for different transmissions. Finally, the total MAPC per TxOp capacity (e.g., SR TxOp capacity) can be improved when implementing multi-band MAPC.

Existing MAPC techniques conduct coordination individually for each band using a single mode, such as C-SR. To utilize the multi-band AP infrastructure, techniques for implementing multi-band MAPC can include intelligently adapting to per-band opportunities and constraints and opportunistically utilizing multi-band APs as one large virtual MAPC pipe. To implement multi-band MAPC, key requirements may include protocols for APs to discover similar multi-band APs and share band-specific loading and interference status for coordination. Multi-band MAPC scheduling algorithms that dynamically select different modes on different bands based on each band's conditions and standardized changes to enable heterogeneous MAPC operation using independent modes concurrently in different bands are also potential requirements.

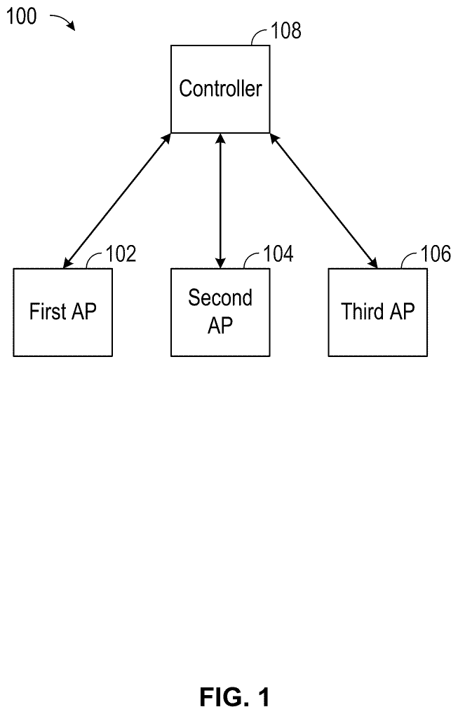

FIG. 1 is a block diagram of an operating environment 100 for supporting multi-band MAPC coordination. The operating environment 100 may include a first AP 102, a second AP 104, a third AP 106, and a controller 108. The first AP 102, the second AP 104, and the third AP 106 may enable clients to connect to the network. Client devices (e.g., a STA) can be any device connects to the network to communicate with other devices on the network, such as a smart phone, a tablet, a personal computer, a server, and/or the like. The controller 108 may be any network controller (e.g., a Wireless Local Area Network (WLAN) controller) and may manage the first AP 102, the second AP 104, the third AP 106, and/or other network devices to allow wireless devices to connect to the network. The operations of the controller 108 may be performed by one or more of the first AP 102, the second AP 104, and the third AP 106 in some embodiments. For example, one of the first AP 102, the second AP 104, and the third AP 106 may be a primary AP that controls the other APs or otherwise instructs the other APs how to operate. The operating environment 100 is an example configuration and there may be a different number of APs, controllers, and/or other devices in further examples.

The first AP 102, the second AP 104, and the third AP 106 may be within range of each other and be operating on one or more of the same bands. Thus, the first AP 102, the second AP 104, and the third AP 106 may implement multi-band MAPC, for example to utilize the available capacity of all bands, utilize favorable characteristics of each band for certain transmissions, and so on. To implement multi-band MAPC, the first AP 102, the second AP 104, and the third AP 106 may exchange a multi-band MAPC capabilities element. The multi-band MAPC capabilities element may indicate or otherwise contain information about the bands and AP is operating on and the MAPC modes the AP supports.

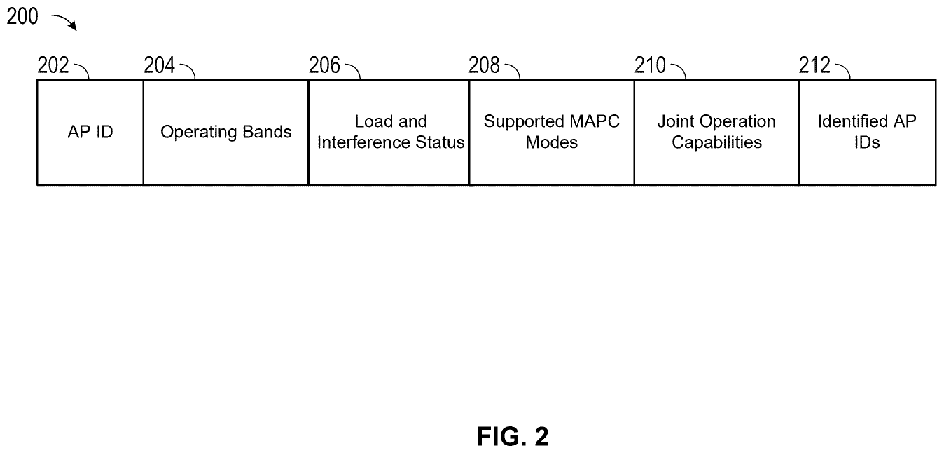

FIG. 2 is a block diagram of a multi-band MAPC capabilities element 200. The multi-band MAPC capabilities element 200 may include an AP ID field 202, an operating bands field 204, a load and interference status field 206, a supported MAPC modes field 208, a joint operation capabilities field 210, and an identified AP IDs field 212. In some examples, the multi-band MAPC capabilities element 200 is part of a data field of a transmission, such as a Physical Layer Protocol Data Unit (PPDU). Therefore, a transmission by an AP including a multi-band MAPC capabilities element 200 may also include a preamble and/or additional fields.

The AP ID field 202 indicates or otherwise contains information about the AP associated with the multi-band MAPC capabilities element 200. For example, the first AP 102 will include an identifier of the first AP 102 in the AP ID field 202 when sending a multi-band MAPC capabilities element 200 to the second AP 104 and/or the third AP 106. The operating bands field 204 may indicate or otherwise contain information about the bands the associated AP is operating in. For example, the first AP 102 may indicate that it is operating in the 2.4 GHz band, the 5 GHz band, and the 6 GHz band in the operating bands field 204. The load and interference status field 206 can indicate or otherwise contain information about the load status (e.g., number of clients, amount of traffic) and interference status (e.g., previously experienced interference with another AP) for each band the associated AP is operating on. The load status and interference status information can be used to determine how to implement multi-band MAPC to utilize the bands to distribute the traffic load efficiently and to reduce or eliminate interference.

The supported MAPC modes field 208 indicates or otherwise contains information about the MAPC modes the associated AP supports for each band. For example, the first AP 102 may indicate that it supports C-SR, C-TDMA, Coordinated-Orthogonal Frequency-Division Multiple Access (C-OFDMA), Coordinated-Frequency-Division Multiple Access (C-FDMA), and/or the like for one or more the bands the first AP 102 is operating in. In some embodiments, the supported MAPC modes field 208 also includes a preferred mode for one or more of the bands. For example, the first AP 102 may indicate that it prefers to use C-TDMA for a first band, C-SR for a second band, and standard operation (e.g., the Institute of Electrical and Electronics Engineers (IEEE) 802.11 legacy mode) for a third band. The joint operation capabilities field 210 may indicate or otherwise contain information about the joint operations the associated AP can perform (e.g., Multi-Link Operation (MLO) capabilities, Non-Simultaneous Transmit and Receive (NSTR) mode for one or more bands, Simultaneous Transmit and Receive (STR) mode for one or more bands). The joint operation capabilities field 210 may therefore indicate possible configurations of the multi-band MAPC. For example, if one or more of the APs implementing the multi-band MAPC require a NSTR mode where simultaneous receiving and transmitting operations are not possible, the multi-band MAPC implementation may have less flexibility with transmission and/or receiving operations having to be aligned across link and/or bands of one or more of the APs.

The identified AP IDs field 212 may indicate or otherwise contain information about APs the associated AP has identified for implementing multi-band MAPC. For example, the first AP 102 may include an identifier of the third AP 106 when sending a multi-band MAPC capabilities element 200 to the second AP 104, may include an identifier of the second AP 104 when sending a multi-band MAPC capabilities element 200 to the third AP 106, and/or the like. Thus, the APs can use identified AP IDs field 212 to determine if the identified APs can be used in the same multi-band MAPC implementation and/or whether an AP has information for each candidate AP for the multi-band MAPC implementation.

The first AP 102, the second AP 104, the third AP 106 may exchange multi-band MAPC capabilities elements 200, and one or more of the first AP 102, the second AP 104, the third AP 106 may determine which bands each AP will operate on, the configuration for operating on each band, and/or other characteristics of the multi-band MAPC. For example, the first AP 102 may act as a coordinating AP, receive a multi-band MAPC capabilities element 200 from the second AP 104 and the third AP 106, configure the multi-band MAPC implementation based on the information in the multi-band MAPC capabilities elements 200 and the characteristics of the first AP 102, and notify or otherwise cause the second AP 104 and the third AP 106 to operate according to the multi-band MAPC implementation. As will be described in further detail below, the first AP 102 may form a multi-band MAPC Coordination Group (CG) with the second AP 104 and the third AP 106 when the first AP 102 notifies or otherwise causes the second AP 104 and the third AP 106 to operate according to the multi-band MAPC implementation. Thus, the coordinating AP creating a multi-band MAPC CG may be an extension of the MAPC over-the-air discovery protocol. In an example implementation, the first AP 102 determines the first AP 102, the second AP 104, and the third AP 106 will operate on the 2.4 GHz band, the 5 GHz band, and the 6 GHz band using one or more MAPC modes (e.g., C-SR, C-OFDMA, C-TDMA, C-FDMA, etc.). Different MAPC modes may be used for the different bands. The coordinating AP may use a scheduling algorithm to dynamically select different MAPC modes on different bands tailored to each band's conditions (e.g., load, interference history, APs operating on the band, and/or the like).

In some embodiments, the controller 108 may determine the multi-band MAPC implementation. The controller 108 may receive a multi-band MAPC capabilities element 200 from the first AP 102, the second AP 104, and the third AP 106, configure the multi-band MAPC implementation based on the information in the multi-band MAPC capabilities elements 200, and notify or otherwise cause the first AP 102, the second AP 104, and the third AP 106 to operate according to the multi-band MAPC implementation, for example including forming a multi-band MAPC CG including first AP 102, the second AP 104, and the third AP 106. The controller 108 may use a scheduling algorithm to dynamically select different MAPC modes on different bands tailored to each band's conditions. Thus, a coordinating AP or a network controller is operable to implement multi-band MAPC.

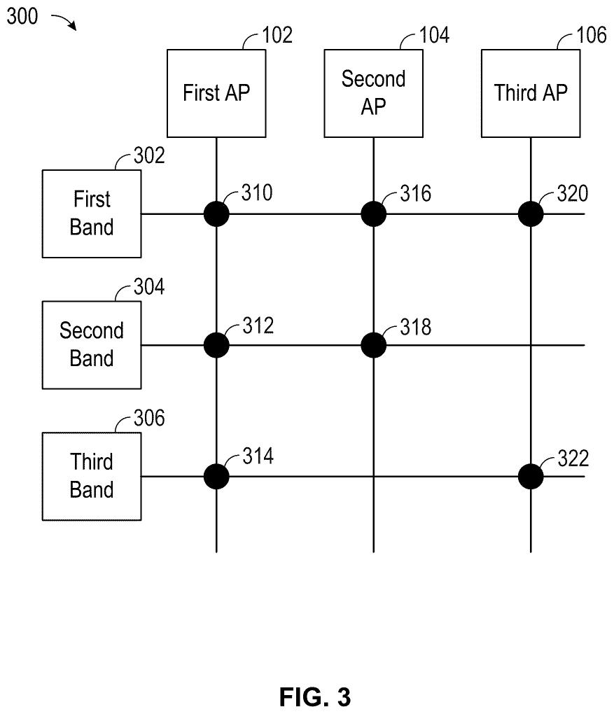

FIG. 3 is a block diagram of an example AP configuration 300 for supporting multi-band MAPC. The example AP configuration 300 includes the first AP 102, the second AP 104, and the third AP 106 operating on one or more of a first band 302, a second band 304, and a third band 306. In some embodiments, the first band 302 is the 2.4 GHz band, the second band 304 is the 5 GHz band, and the third band 306 is the 6 GHz band. The first AP 102 may have a first link 310 on the first band 302, a second link 312 on the second band 304, and a third link 314 on the third band 306. The second AP 104 may have a fourth link 316 on the first band 302 and a fifth link 318 on the second band 304. The third AP 106 may have a sixth link 320 on the first band 302 and a seventh link 322 on the third band 306.

The first AP 102 may send a multi-band MAPC capabilities element 200 to the second AP 104 and/or the third AP 106 indicating an identifier of the first AP 102 in the AP ID field 202, an identifier of the first link 310, the second link 312, and the third link 314 (i.e., operating on the first band 302, the second band 304, and the third band 306) in the operating bands field 204, indicate the load status and interference status for the first link 310, the second link 312, and/or the third link 314 in the load and interference status field 206, indicate supported MAPC modes for the first link 310, the second link 312, and/or the third link 314 in the supported MAPC modes field 208, and joint operation capabilities for the first link 310, the second link 312, and/or the third link 314 in the joint operation capabilities field 210. Similarly, the second AP 104 may send a multi-band MAPC capabilities element 200 to the first AP 102 and/or the third AP 106 indicating an identifier of the second AP 104 in the AP ID field 202, an identifier of the fourth link 316 and the fifth link 318 (i.e., operating on the first band 302 and the second band 304) in the operating bands field 204, indicate the load status and interference status for the fourth link 316 and/or the fifth link 318 in the load and interference status field 206, indicate supported MAPC modes for the fourth link 316 and/or the fifth link 318 in the supported MAPC modes field 208, and joint operation capabilities for the fourth link 316 and/or the fifth link 318 in the joint operation capabilities field 210. The third AP 106 may send a multi-band MAPC capabilities element 200 to the first AP 102 and/or the second AP 104 indicating an identifier of the third AP 106 in the AP ID field 202, an identifier of the sixth link 320 and the seventh link 322 (i.e., operating on the first band 302 and the third band 306) in the operating bands field 204, indicate the load status and interference status for the sixth link 320 and/or the seventh link 322 in the load and interference status field 206, indicate supported MAPC modes for the sixth link 320 and/or the seventh link 322 in the supported MAPC modes field 208, and joint operation capabilities for the sixth link 320 and/or the seventh link 322 in the joint operation capabilities field 210. In example implementations, the first AP 102, the second AP 104, and the third AP 106 send the multi-band MAPC capabilities elements 200 to the controller 108. Thus, a coordinating AP or the controller 108 can implement multi-band MAPC across the first band 302, the second band 304, and the third band 306 using the first link 310, the second link 312, the third link 314, the fourth link 316, the fifth link 318, the sixth link 320, and/or the seventh link 322 (e.g., using a scheduling algorithm to dynamically select different MAPC modes on different bands tailored to each band's conditions). For example, the first AP 102, the second AP 104, and the third AP 106 share the first band 302, the first AP 102, and the second AP 104 share the second band 304, and the first AP 102 and the third AP 106 share the third band 306. In an example implementation, C-SR and C-TDMA are enabled on the first band 302, C-OFDMA and C-TDMA are enabled on the second band 304, and C-OFDMA and C-SR are enabled on the third band 306 based on the conditions of the first band 302, the second band 304, and the third band 306.

In some embodiments, instead of forming per-band CGs, a multi-band MAPC CG may consist of APs that are co-band. For example, the first AP 102, the second AP 104, and the third AP 106 may be co-band on the 2.4 GHz band, the 5 GHZ band, and the 6 GHz band in an example implementation. A coordination group of co-band APs can provide a virtual MAPC pipe (e.g., medium for transmitting and receiving) that can be scheduled and managed as a single joint entity. The multi-band MAPC CG can be formed according to the operations described above, including exchanging multi-band MAPC capabilities elements 200 and configuring an initial multi-band MAPC implementation.

The formation and/or maintenance of the multi-band MAPC CGs may be dynamic, for example based on the operations and information described above, the connectivity of the co-band APs on multiple bands, changing load and interference characteristics, and/or the like. When a multi-band MAPC CG is formed, the device that creates the multi-band MAPC CG (e.g., the coordinating AP, the controller 108) may set a predefined period for the multi-band MAPC CG to exist. For example, the multi-band MAPC CG may exist for hundred or thousands of TxOps in example implications. In some embodiments, a device managing the multi-band MAPC CG (e.g., a coordinating AP, the controller 108) may monitor the operation of the multi-band MAPC CG and extend the period of the multi-band MAPC CG (e.g., when the multi-band MAPC CG remains stable) or dissolve the multi-band MAPC CG before the established period (e.g., when the multi-band MAPC CG implementation is not operating as desired or otherwise expected).

The coordinating AP or the controller 108 can simultaneously coordinate different MAPC modes in different bands by selectively scheduling APs in the multi-band MAPC CG, clients, and/or modes in each band's TxOps. For example, the coordinating AP or the controller 108 can concurrently schedule TxOps on the first band 302 using C-OFDMA, TxOps on the second band 304 using C-TDMA, and TxOps on the third band 306 using C-SR. Thus, the first AP 102, the second AP 104, and the third AP 106 can operate using multiple MAPC modes at the same time on different bands.

The coordinating AP or the controller 108 may track or otherwise be aware of the loads and/or other status information of the APs in the multi-band MAPC CG across bands that they share. Thus, the coordinating AP or the controller 108 can identify when an AP is congested or otherwise operating inefficiently on one or more bands, has availability on one or more bands, and the like. Using the information about the current loads and/or other status information the coordinating AP or the controller 108 can adjust loads, such as loads on a congested link, to a link with sufficient capacity, lower-latency, and/or the like via cross-band allocation.

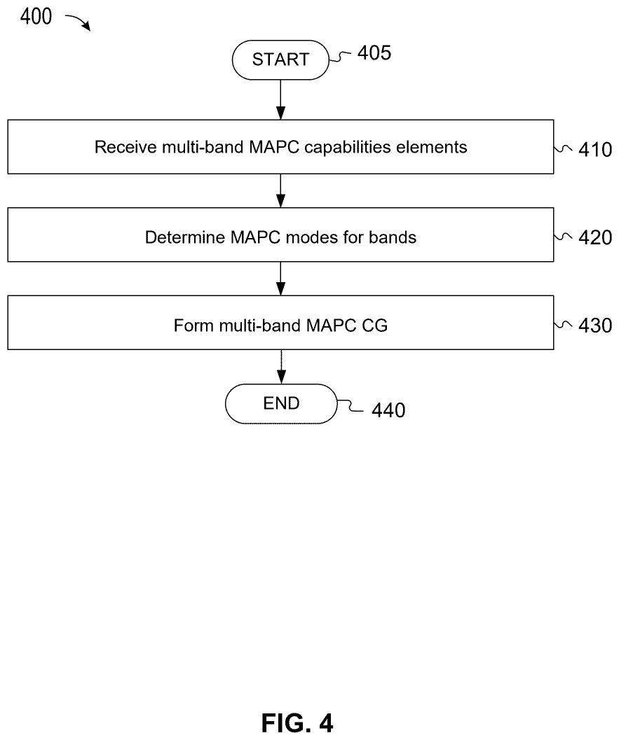

FIG. 4 is a flow chart of a method 400 for supporting multi-band MAPC. The method 400 may begin at starting block 405 and proceed to operation 410. In operation 410, one or more multi-band MAPC capabilities elements are received from one or more APs. For example, the first AP 102, operating as a coordinating AP, receives multi-band MAPC capabilities elements 200 from the second AP 104 and the third AP 106. The multi-band MAPC capabilities elements 200 may include any of the information described above, such as the AP ID, operating bands, load and interference information, supported MAPC modes, joint operation capabilities, and/or the like.

In operation 420, MAPC modes are determined for a plurality of bands. For example, the first AP 102 determines a MAPC mode for the first AP 102, the second AP 104, and/or the third AP 106 to operate in for the first band 302, the second band 304, and the third band 306. The MAPC modes can be C-SR, C-TDMA, C-OFDMA, C-FDMA, and/or the like. For example, the first AP 102 determines to use C-SR in the first band 302, C-TDMA in the second band 304, and C-OFDMA in the third band 306.

In operation 430, a multi-band MAPC CG is formed. For example, the first AP 102 forms a multi-band MAPC CG including the first AP 102, the second AP 104, and the third AP 106. The first AP 102 may schedule transmissions, control MAPC modes on the band, organize loads across bands, and/or the like for the multi-band MAPC CG.

In some examples, the first AP 102 may determine one or more the APs in the multi-band MAPC CG are operating in a NSTR mode and configure the multi-band MAPC CG to align transmission end times. The first AP 102 may also set a period for the multi-band MAPC CG to exist, such as for hundreds or thousands of TxOps. The first AP 102 can extend the period when the multi-band MAPC CG is stable or dissolve the multi-band MAPC CG when operation is not as desired. The method 400 may conclude at ending block 440.

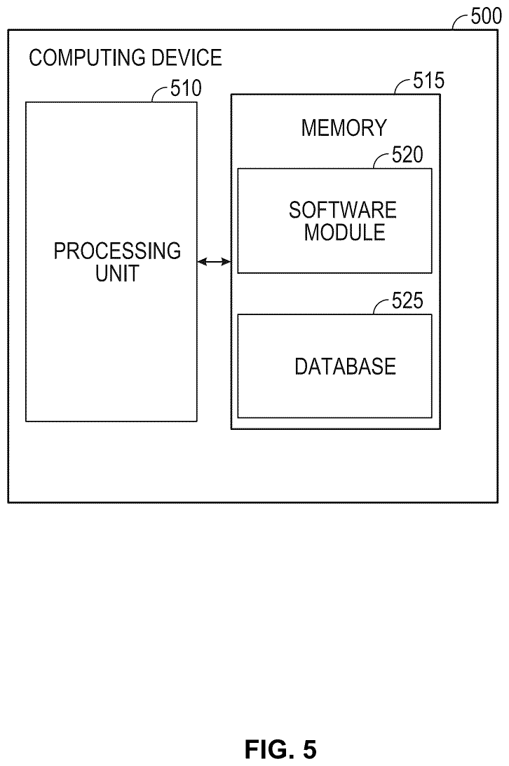

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for supporting multi-band MAPC with respect to FIG. 1, FIG. 2, FIG. 3, and FIG. 5. Computing device 500, for example, may provide an operating environment for the first AP 102, the second AP 104, the third AP 106, the controller 108, and the like. The first AP 102, the second AP 104, the third AP 106, the controller 108, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving one or more multi-band Multi-Access Point (AP) Coordination (MAPC) capabilities elements from one or more APs;
determining one or more MAPC modes for a plurality of bands based on the one or more multi-band MAPC capabilities elements; and
forming a multi-band MAPC Coordination Group (CG) including the one or more APs, wherein the multi-band MAPC CG uses the one or more MAPC modes for the plurality of bands.

2. The method of claim 1, wherein the one or more multi-band MAPC capabilities elements comprise any one of: (i) an AP ID field indicating an identity of an associated AP, (ii) an operating band field indicating information about bands the associated AP is operating in, (iii) a load and interference status field indicating information about a load status and an interference status of the associated AP, (iv) a supported MAPC modes field indicating one or more supported MAPC modes of the associated AP, (v) a joint operation capabilities field indicating one or more joint operation capabilities of the associated AP, or (vi) any combination of (i)-(v).

3. The method of claim 1, wherein the one or more MAPC modes comprise any one of (i) Coordinated-Spatial Reuse (C-SR), (ii) Coordinated-Time Division Multiple Access (C-TDMA), (iii) Coordinated-Orthogonal Frequency-Division Multiple Access (C-OFDMA), (iv) Coordinated-Frequency-Division Multiple Access (C-FDMA), or (v) any combination of (i)-(iv).

4. The method of claim 1, further comprising:
determining an AP of the one or more APs operates in a Non-Simultaneous Transmit and Receive (NSTR) mode; and
configuring the multi-band MAPC CG to align transmission end times in response to determining the AP of the one or more APS operates in the NSTR mode.

5. The method of claim 1, wherein forming the multi-band MAPC CG comprises setting a period for the multi-band MAPC CG to exist.

6. The method of claim 5, further comprising:
monitoring the multi-band MAPC CG;
when the multi-band MAPC CG is stable, extending the period; and
when the multi-band MAPC CG is not operating as desired, dissolving the multi-band MAPC CG.

7. The method of claim 1, wherein determining the one or more MAPC modes for the plurality of bands comprises any one of: (i) determining to use C-TDMA for a first band, (ii) determining to use C-OFDMA for a second band, (iii) determining to use C-SR for a third band, or (iv) any combination of (i)-(iii).

8. The method of claim 1, wherein forming the multi-band MAPC CG comprises scheduling transmissions of the one or more APs using the one or more MAPC modes for the plurality of bands.

9. A system comprising:
a memory storage; and
a processing unit coupled to the memory storage, wherein the processing unit is operative to:
receive one or more multi-band Multi-Access Point (AP) Coordination (MAPC) capabilities elements from one or more APs;
determine one or more MAPC modes for a plurality of bands based on the one or more multi-band MAPC capabilities elements; and
form a multi-band MAPC Coordination Group (CG) including the one or more APs, wherein the multi-band MAPC CG uses the one or more MAPC modes for the plurality of bands.

10. The system of claim 9, wherein the one or more multi-band MAPC capabilities elements comprise any one of: (i) an AP ID field indicating an identity of an associated AP, (ii) an operating band field indicating information about bands the associated AP is operating in, (iii) a load and interference status field indicating information about a load status and an interference status of the associated AP, (iv) a supported MAPC modes field indicating one or more supported MAPC modes of the associated AP, (v) a joint operation capabilities field indicating one or more joint operation capabilities of the associated AP, or (vi) any combination of (i)-(v).

11. The system of claim 9, wherein the processing unit is further operative to:
determine an AP of the one or more APs operates in a Non-Simultaneous Transmit and Receive (NSTR) mode; and
configure the multi-band MAPC CG to have align transmission end times in response to determining the AP of the one or more APS operates in the NSTR mode.

12. The system of claim 9, wherein to form the multi-band MAPC CG comprises to set a period for the multi-band MAPC CG to exist.

13. The system of claim 12, wherein the processing unit is further operative to:
monitor the multi-band MAPC CG;
when the multi-band MAPC CG is stable, extend the period, and
when the multi-band MAPC CG is not operating as desired, dissolve the multi-band MAPC CG.

14. The system of claim 9, wherein to determine the one or more MAPC modes for the plurality of bands comprises any one of: (i) to determine to use C-TDMA for a first band, (ii) to determine to use C-OFDMA for a second band, (iii) to determine to use C-SR for a third band, or (iv) any combination of (i)-(iii).

15. The system of claim 9, wherein to form the multi-band MAPC CG comprises to schedule transmissions of the one or more APs using the one or more MAPC modes for the plurality of bands.

16. A non-transitory computer-readable medium that stores a set of instructions which when executed perform a method executed by the set of instructions comprising:
receiving one or more multi-band Multi-Access Point (AP) Coordination (MAPC) capabilities elements from one or more APs;
determining one or more MAPC modes for a plurality of bands based on the one or more multi-band MAPC capabilities elements; and
forming a multi-band MAPC Coordination Group (CG) including the one or more APs, wherein the multi-band MAPC CG uses the one or more MAPC modes for the plurality of bands.

17. The non-transitory computer-readable medium of claim 16, wherein the one or more multi-band MAPC capabilities elements comprise any one of: (i) an AP ID field indicating an identity of an associated AP, (ii) an operating band field indicating information about bands the associated AP is operating in, (iii) a load and interference status field indicating information about a load status and an interference status of the associated AP, (iv) a supported MAPC modes field indicating one or more supported MAPC modes of the associated AP, (v) a joint operation capabilities field indicating one or more joint operation capabilities of the associated AP, or (vi) any combination of (i)-(v).

18. The non-transitory computer-readable medium of claim 16, the method executed by the set of instructions further comprising:
determining an AP of the one or more APs operates in a Non-Simultaneous Transmit and Receive (NSTR) mode; and
configuring the multi-band MAPC CG to have align transmission end times in response to determining the AP of the one or more APS operates in the NSTR mode.

19. The non-transitory computer-readable medium of claim 16, the method executed by the set of instructions further comprising:
monitoring the multi-band MAPC CG;
when the multi-band MAPC CG is stable, extending a period the multi-band MAPC CG exists; and
when the multi-band MAPC CG is not operating as desired, dissolving the multi-band MAPC CG.

20. The non-transitory computer-readable medium of claim 16, wherein the one or more MAPC modes comprise any one of (i) Coordinated-Spatial Reuse (C-SR), (ii) Coordinated-Time Division Multiple Access (C-TDMA), (iii) Coordinated-Orthogonal Frequency-Division Multiple Access (C-OFDMA), (iv) Coordinated-Frequency-Division Multiple Access (C-FDMA), or (v) any combination of (i)-(iv).
